(19) United States
(12) Patent Application Publication
(10) Pub. No.: US 2007/0043658 A1
(43) Pub. Date: Feb. 22, 2007

(54) Computer Assisted Loan Insurance Determination

(76) Inventors: William DiPaolo, San Diego, CA (US); Alan J. Baia, San Diego, CA (US)

Correspondence Address: WILSON SONSINI GOODRICH & ROSATI, 650 PAGE MILL ROAD, PALO ALTO, CA, 94304-1050, US

(21) Appl. No.: 11/466,408

(22) Filed: Aug. 22, 2006

Related U.S. Application Data
(60) Provisional application No. 60/710,059, filed on Aug. 22, 2005.

(51) Int. Cl. G06Q 40/00

(52) U.S. Cl. 705/38

(57) ABSTRACT

The instant invention provides methods where a negotiated sales price can be verified as an acceptable home value without the need to hire or wait for an appraiser. The instant invention also provides methods for refinancing, where an acceptable home value for a refinance is determined and used for the size of a refinance loan. In some embodiments of the invention, a lender using the instant invention obtains insurance based on the acceptable home value in a real estate purchase or refinance.

### CROSS-REFERENCE

This application claims priority to the U.S. Provisional Application No. 60/710,059 filed Aug. 22, 2005 entitled “Computer Assisted Loan Insurance Determination” which is hereby incorporated by reference in its entirety including the figures and drawings.

### BACKGROUND OF THE INVENTION

A fundamental problem in funding real estate loans that banks and other lenders face concerning the appraisal process is the speed of delivery of the appraisal; loans that banks otherwise wish to fund are being lost because of the delay in getting the property in question appraised. Because obtaining an appraisal can take anywhere from a week to two weeks, banks can lose loans, and thus valuable income, in the time to get an appraisal. An alternative to the appraisal process exists in Automated Valuation Models (AVMs) described further below. (See, e.g., VeroVALUE (Santa Ana, Calif.), CASA® (Cambridge, Mass.), HPASM (First American Real Estate Solutions, Anaheim, Calif.), and HVE® via CSC (Freddie Mac, McLean, Va.).

The use of AVMs, however, represents another fundamental problem in the process of funding real estate loans. Banks encounter a difficulty in the direct use of AVMs since the AVM value opinions provided by commercial services are often less than the transaction price agreed between the buyer and seller of the real property. A bank that evaluates collateral value using AVMs would lose too many loans.

In a physical appraisal, a human being (the appraiser) may drive by or walk through the property to assess its present condition. Tax records and Multiple Listing Service (MLS) listings are consulted to assess recent sales trends in the neighborhood for similar properties. The appraiser issues an opinion of value for the property which then becomes the bank's value for its loan to value calculations.

If the value is lower than the transaction price, the appraiser may be asked to modify (raise) the opinion of value based on additional property data. If the value cannot be raised the bank will reduce its lending limit for the loan to be secured by the property. This approach creates risk in property valuation since personal bias, differing valuation methodologies, human error and fraud can lead to inaccurate values. When multiplied across a loan portfolio, the collateral risk may result in lower prices offered by investors.

Bank lending guidelines limit mortgage loan sizes with predefined loan to value ratios, which value is defined as the current market value of the purchased property. Lenders currently define value through use of a professional opinion of value on the subject property. This opinion, called a property appraisal or appraisal, is calculated manually by an appraiser or electronically via automated valuation models (“AVMs”). The bank then sets the property's value at the lesser of either the appraised value or the sales transaction price. The maximum loan amount then becomes the down payment amount subtracted from the value. The opinion of value is calculated independent of the actual sales price negotiated between buyer and seller.

A few of the companies that produce computer generated AVMs recently introduced an insurance component that reportedly guarantees or insures the accuracy of their computer generated value opinion.

AVMs generally calculate value opinions using tax and sales data on previous home sales. Consequently AVMs typically come in lower than the transaction price due to home appreciation, competitive bidding, or seller negotiation skills. Lenders therefore cannot use AVMs, even when insured, because results come in lower than the transaction price up to 98% of the time. This results in too many lost loans.

While this approach removes human bias, it does not consider the negotiated sales price, nor does it solve the problem of what to do when the sales transaction price is higher than the insured opinion of value. In fact, the lack of human intervention raises a different problem in that values that cannot be raised like physical appraisals.

Thus, existing business methods cause difficulties for home purchasers and their lenders when the appraiser's opinion of value comes in lower than the negotiated sales price. In these instances the bank offers a lower loan amount and the borrower must come up with more cash (in addition to the required down payment), or walk away from the proposed purchase.

As an illustration, consider a family of modest income that desires a new home and is pre-qualified for $150,000 with a cash down payment of five percent, or $7,500. After several weeks of house shopping they find a home that fits their personal tastes. After negotiation with the seller they agree to buy the home for $145,000. Since the buyer is pre-qualified for $150,000, the prospect looks favorable. The bank now orders an appraisal to verify the market value of the property. The independent opinion results in a value of $141,000, which then becomes the property's value. Subtracting the required 5%, the family must now come up with a $10,600 down payment to buy the home at the seller's required price of $145,000. If the family cannot find the $3,100 above the expected $7,500 from pre-qualification, it can't finance the home and the lender loses the loan.

The appraisal industry has responded to the pressure to deliver an opinion of value that meets or exceeds the sales transaction price. According to an February, 2004 study done by October Research, Inc., 99% of all appraisers feel pressured to deliver inflated opinions of values in order to satisfy their lender clients. In our own research more than 98% of value opinions came in equal to or greater than the sales price. How does the lender know if the opinion of value is accurate or inflated due to pressure to meet a specific valuation number? How can the lender measure its risk incurred when securing a loan with collateral of uncertain value? On the other end of the spectrum, our research (confirmed by one of the nations largest lenders), showed that AVM generated valuation opinions come in lower than the negotiated sales price more than 98% of the time. Since banks cannot use opinions of value even $1.00 less than the sales (transaction) price, the bank must eliminate the use of AVMs to validate the transaction price 98% of the time. Accordingly, the appraisals generated using the existing business methods are inadequate to serve the needs of the real estate funding industry.

As noted above, use of the existing business methods creates a problem that banks are having with the appraisal process in funding real estate loans—that is the speed of delivery; perfectly reasonable loans are being lost because of the delay in getting property appraised. It's taking anywhere from a week to two weeks to get an appraisal turned around; banks can lose loans in that time. Further, banks have a difficulty in the use of AVMs directly as AVM value opinions are usually less than the transaction price. A bank that evaluates collateral value using AVMs loses too many loans.

### SUMMARY OF THE INVENTION

By the use of the instant invention, negotiated sales price can be verified as an acceptable home value without the need to hire or wait for an appraiser. Once the lender agrees to use instant invention, and agrees to accept insurance obtained by means of the instant invention, the lender is not involved in the process except to the extent of issuing the loan.

The advantages of the instant invention over the existing business methods are apparent. For example, if the applicant (also known as the borrower or property-buyer) is pre-qualified for a loan amount, the mortgage broker can meet with the applicant and the real estate agent, and the mortgage broker can instantly validate the sales (transaction) price for the property and obtain a loan for up to the pre-approved amount. In some embodiments, the mortgage broker meets the other parties face-to-face, in other embodiments, the mortgage broker meets them telephonically, in still other embodiments, the mortgage broker meets them over the Internet. One advantage of the instant invention is that the negotiated sales price for the home can be instantly validated without needing to purchase a third party opinion of value from either an appraiser or an AVM.

In a first aspect, the invention features a computerized mortgage loan evaluation method comprising a number of, or all of, the following steps: first, inputting into a computer/database/program (a) the Agreed Sale Price between a borrower and a seller for a piece of real property (b) the identity of the borrower, (c) the identity and location of the property, (d) both the amount of cash provided by the borrower (e.g., the down payment), (e) the requested loan amount, and (f) the Proximity Percentage and Approval Rating requested by the loan originator and/or insurer; second, retrieving a set of currently available AVMs; third, selecting a subset of AVMs from a set of available AVMs; and fourth, approving a Transaction Assurance Policy (TAP) if: (a) there are three or four AVMs present in the subset of AVMs, (b) the AVMerge Value calculated from the selected subset of AVMs is calculated after the selected subset of AVMs has been subjected to Outlier Analysis (if necessary), (c) the selected subset of AVMs has been subjected to focusing analysis (if necessary), (d) the calculated AVMerge Value is within the Proximity Percentage of the Agreed Sale Price, and (e) AVMerge Index calculated from the selected subset of AVMs is greater than the Approval Rating.

In another aspect, the invention features a computerized mortgage loan evaluation method comprising a number of, or all of, the following steps: first, inputting into a computer/database/program: (1) the Agreed Sale Price between a borrower or property-buyer and a seller for a piece of real property, (2) the identity of this borrower or property-buyer, (3) the unique identity of the property in question (usually the location), (4) the amount of cash provided by this borrower or property-buyer (e.g., the down payment), (5) the requested amount of the loan, and (6) the Proximity Percentage and Approval Rating requested by the loan originator and/or insurer; second, obtaining and inputting into the computer/program/database a plurality of AVMs for the property, or a list of available AVMs for the property; third, evaluating the available AVMs to obtain a subset of AVMs; fourth, calculating the AVMerge Value; and fifth, comparing this AVMerge Value to the Agreed Sale Price and calculating the AVMerge Index; wherein a TAP is approved and/or issued if both: (1) the calculated AVMerge Value is within the Proximity Percentage of the Agreed Sale Price; and (2) the AVMerge Index is greater than the Approval Rating.

In a further aspect, the invention features a computerized mortgage loan evaluation method comprising a number of, or all of, the following steps: (1) inputting into a computer/database/program the following information: (a) the Agreed Sale Price for a piece of real property between a borrower or property-buyer and a seller, (b) the identity of this borrower or property-buyer, (c) the unique identity of the property in question (usually the location), (d) the amount of cash provided by the prospective borrower or property-buyer (e.g., the down payment), (e) the requested loan amount, (f) the Proximity Percentage and Approval Rating requested by the loan originator and/or insurer, and (g) retrieving a set of currently available AVMs; and (2) attempting to select a subset of AVMs wherein the meet the following qualifications: (1) the subset of AVMs comprises three or four individual AVMs, (2) this subset of AVMs have an AVMerge Value within a Proximity Percentage of the Agreed Sale Price either with or without focusing of the AVMerge Value, (3) this subset of AVMs has an AVMerge Index greater than the Approval Rating with or without Outlier Analysis; and wherein a TAP is approved and/or issued if both: the calculated AVMerge Value is within the Proximity Percentage of the Agreed Sale Price; and the calculated AVMerge Index is greater than the Approval Rating.

In yet another aspect, the invention features a computerized mortgage loan evaluation method comprising a number of, or all of, the following steps: (1) inputting into a computer/database/program the following: (a) the requested loan amount by a borrower for refinancing a piece of real property, (b) the identity of the borrower, (c) the unique identity of the property (usually the location), (d) the amount of cash and/or equity in the real property provided by the borrower, and (e) the Proximity Percentage and Approval Rating requested by the loan originator or insurer; (2) retrieving a set of currently available AVMs; and (3) selecting a subset of AVMs from the available set of AVMs; wherein a TAP is approved and/or issued if the following conditions are met: (1) the selected subset of AVMs comprises three or four individual AVMs, (2) the selected subset of AVMs have a calculated AVMerge Index following Outlier Analysis greater than the Approval Rating, and (3) the selected subset of AVMs has a Focused AVMerge Value within the Proximity Percentage of the Agreed Sale Price.

In a still further aspect, the invention features a computerized mortgage loan evaluation method comprising a number of, or all of, the following steps: first, inputting into a computer/database/program the following information: (1) the requested loan amount by a borrower for refinancing a piece of real property; (2) the identity of the prospective borrower, (3) the unique identity of the property (usually the location), (4) the amount of cash and/or equity in the real property provided by the prospective borrower, and (5) the Proximity Percentage and Approval Rating requested by the loan originator or insurer; second, obtaining and inputting a plurality of AVMs for the property, or a list of available AVMs for the property into the computer/database/program; third, (b) evaluating the available AVMs to obtain a subset of AVMs; fourth, calculating the AVMerge Value; and fifth, comparing the AVMerge Value to the Agreed Sale Price and calculating the AVMerge Index; wherein a TAP is approved and/or issued if both: (1) the calculated AVMerge Value is within the Proximity Percentage of the Agreed Sale Price; and the calculated AVMerge Index is greater than the Approval Rating. In one embodiment of this aspect, the methods of the instant invention may be used to determine the maximum loan size available by the relationship between the AVMerge Value and the loan size plus borrower equity for the property in question.

In yet a still further aspect the invention features a computerized mortgage loan evaluation method comprising a number of, or all of the following steps of: first, inputting into a computer/database/program the following information: (1) the requested loan amount by a borrower for refinancing a piece of real property, (2) the identity of this borrower, (3) the unique identity of the property (usually the location), (4) the amount of cash and/or equity in the real property provided by the borrower, and (5) the Proximity Percentage and Approval Rating requested by the loan originator or insurer; second, (2) retrieving a set of currently available AVMs; and third, attempting to select a subset of AVMs wherein: (1) the subset of AVMs comprises three or four individual AVMs, (2) the subset of AVMs have an AVMerge Value within a Proximity Percentage of the Agreed Sale Price either with or without focusing the AVMerge Value, (3) the subset of AVMs have an AVMerge Index greater than the Approval Rating with or without Outlier Analysis; and wherein a TAP is approved and/or issued if both: (1) the AVMerge Value is within the Proximity Percentage of the Agreed Sale Price; and (2) the AVMerge Index is greater than the Approval Rating.

In another aspect, the instant invention features a computerized mortgage loan evaluation method for refinancing a piece of real property comprising the steps of: (1) inputting into a computer/database/program the following: (a) the identity of a borrower, (b) a unique identity of the property, (c) an amount of cash and/or equity in towards the financing of the real property provided by the borrower, (d) a Proximity Percentage and an Approval Rating requested by a loan originator or insurer, and (e) retrieving a list of currently available AVMs; and (2) selecting a subset of AVMs from the available set of AVMs; (3) using the Proximity Percentage and the amount of cash and/or equity provided by the borrower to calculate the maximum available loan, wherein a TAP is approved and/or issued if (a) the subset of AVMs has an AVMerge Index greater than the Approval Rating, (b) the loan requested is less than or equal to the maximum available loan, and (c) the subset of AVMs has a Focused AVMerge Value within the Proximity Percentage of the Agreed Sale Price. In one embodiment of the instant invention the maximum loan size available with or without a TAP for a given borrower and property is determined. In other embodiments of the invention, a range of loans or loan sizes available with or without a TAP for a given borrower and property is determined.

In any or all of the above aspects, the instant invention features the embodiment wherein the final plurality of AVMs is either 3 or 4.

In any or all of the above aspects, the instant invention features the embodiment wherein the AVMerge Value has been subjected to Focusing Analysis as defined herein.

In any or all of the above aspects, the instant invention features the embodiment wherein the AVMerge Index has been subjected to Outlier Analysis as defined herein.

In any or all of the above aspects, the instant invention features the embodiment wherein three or four AVMs are used.

In any or all of the above aspects, the instant invention features the embodiment wherein four AVMs are used.

In any or all of the above aspects, the instant invention features the embodiment wherein the Proximity Percentage is 90% or more of the Agreed Sale Price.

In any or all of the above aspects, the instant invention features the embodiment wherein the Proximity Percentage is 90% or more of the requested valuation of the real property for obtaining a refinancing loan.

In any or all of the above aspects, the instant invention features the embodiment wherein the Approval Rating is greater than 85.

In any or all of the above aspects, the instant invention features the embodiment wherein the home-buyer and home-seller have negotiated the Agreed Sale Price.

In any or all of the above aspects, the instant invention features the embodiment wherein the Proximity Percentage is less than about 90% or more of the Agreed Sale Price, but more than about 90−X % of the Agreed Sale Price wherein X is about 1, 1, about 2 or 2; and wherein the AVMerge Value is analyzed by a means for conducting a focusing analysis. In one refinement of this embodiment, X is 1. In another refinement of this embodiment, X is 2. In a further refinement of this embodiment, X is about 1. In yet another refinement of this embodiment, X is about 2.

In any or all of the above aspects, the instant invention features the embodiment wherein a TAP is issued following the approval of the TAP.

In any or all of the above aspects, the instant invention features the embodiment wherein a loan is insured based on the approved and/or issued TAP.

In any or all of the above aspects, the instant invention features the embodiment wherein the borrower purchases a First Look option whereby the borrower is told whether or not the TAP is approved but the borrower is not issued the TAP until the borrower requests the TAP to be issued.

In any or all of the above aspects, the instant invention features the embodiment of an apparatus for accomplishing any of the above aspects or embodiments.

These above steps that may be used in the method of instant invention, and the terms described therein, are further described below.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings. With reference to all Figures herein illustrating parts of the instant invention, not all of the illustrated steps are required in all embodiments of the invention.

FIG. 1: An overview of the Outlier Analysis process where the AVM values are clustered near the AVMerge Value and the cutoff value is not relevant. It is noted the variance presented in FIGS. 1-3 is exaggerated for purposes of illustration.

FIG. 2: An overview of the Outlier Analysis process where only three of the four AVM values are clustered near the AVMerge Value.

FIG. 3: Use of Outlier Analysis to remove outlying AVM values and recalculate the AVMerge Value.

FIG. 4: This flow chart represents the overall process for using the instant invention. (Grey shading in the box indicates reference to another chart and/or figure. “<=” means less than or equal to; “>=” means greater than or equal to).

FIG. 5: Flow Chart for Analysis of Pulling AVM. This flow chart represents the analysis of the process of pulling a usable subset of AVMs from the pool of available AVMs.

FIG. 6: Flow Chart for Analysis after the AVM Pull. This flow chart represents the analysis that occurs following the selection of the AVM pool.

FIG. 7: Flow Chart for Calculating AVMerge Index and AVMerge Value. This flow chart represents the process of obtaining the AVMerge Index and AVMerge Value.

FIG. 8: Flow Chart for Flip Detection. This flow chart depicts to process whereby the use of the instant invention can detect potential buyers that are engaging in ‘flipping.’

FIG. 9: Flow Chart for First Look/Activation Analysis.

### DETAILED DESCRIPTION OF THE INVENTION

Herein is described an invention that is an alternative to the property appraisal process for mortgage lenders looking to secure loans using the purchased property as collateral. Moreover, use of the instant invention helps borrowers purchase more homes, lenders fund more loans, and investors purchase portfolios with less risk.

The instant invention solves the problems noted above and eliminates the lender's need to use a third party opinion of value. Instead, the negotiated sales transaction price may be approved as the value of the property using the instant invention and a company issues an insurance policy that protects the lender against valuation error that results in loss of principal during foreclosure. The result of using the methods of the present invention is that borrowers can buy more homes, banks can fund more loans and collateral valuation risk is eliminated for the current and future loan servicer.

(a) Definitions

As used herein, the term “available set of AVMs” refers to any of the AVMs available from any of the vendors available to the user of the instant invention, and include AVMs internally or, preferably, externally generated and/or generally commercially available. Any given AVM may be used irrespective of how it is calculated and what it is called. Any automated property evaluation system equivalent to an AVM may also be used in the instant invention.

As used herein, the term “subset of AVMs” in preferred embodiments refers to a set of AVMs less than the available set of AVMs, and more preferably refers to the set of three or four AVMs, selected as discussed herein, used in the instant invention. In other embodiments, the subset of AVMs is equal to the available set of AVMs.

As used herein, the term “Focused AVMerge Value” is an AVMerge Value that is calculated as described herein where, if necessary, a focusing analysis, as described herein, has been performed. The term “Focused AVMerge Value” in some embodiments of the invention also includes final AVMerge Values where the focusing analysis is not required. The calculation of the AVMerge Value is described in greater detail below.

As used herein, the term “a home-seller” is only used reference in connection to the determination of the Agreed Sale Price, and refers to the party that is selling the property.

As used herein, the term “property-buyer” refers to a buyer or buyers desiring to buy real property, housing property, a home, or a dwelling. In some embodiments this term may be used to encompass a home-owner(s) desiring to refinance her/his/their home. As used herein, the term “borrower” may also refer to a buyer or buyers desiring to buy real property, housing property, a home, or a dwelling.

As used herein, the term “loan-acquirer” refers to an owner or owners desiring to refinance a real property/housing property/a dwelling. As used herein, the term “borrower” may also refer to an owner or owners desiring to refinance a real property/housing property/a dwelling.

As used herein, the term “home-buyer” refers to a buyer or buyers desiring to buy real property/housing property/dwelling. In some cases this term is used to encompass a home-owner(s) desiring to refinance her/his/their real property, housing property, home, or dwelling, i.e., a loan acquirer.

As used herein, referring to a TAP as “approved” means that a TAP satisfies the requirements of one or more embodiments the instant invention and, given a participating insurer, is eligible for obtaining an insurance policy covering the loan amount issued by an insurer. As used herein, an approved TAP may result in a TAP being issued, i.e., made available to the purchaser of the services of the instant invention. An issued TAP may also be referred to herein as a certified TAP, and may also be referred to as obtaining a TAP certification.

As used herein, the term “computer/program/database” refers to a computer equipped with appropriate programming and a database to carry out or facilitate the instant invention, or make the utilization of the instant invention more efficient or effective. As used herein, and as would be apparent to one of skill in the art, in some cases this term is used to signify any individual, or multiples thereof, computer, program, or database, or any combination of the three.

(b) How Does the Invention Work?

The invention uses computer algorithms to instantly (i.e., in a very short period of time) inform the lender if the negotiated sales transaction price can be validated for use as the property's market value in the bank's “loan to value” equation. If so, the computer instantly approves the transaction for an insurer to issue an insurance policy to protect the lender against loss if the value proves incorrect in the event of foreclosure. Moreover, the policy issued as part of the instant invention remains a part of the loan. If the loan should be purchased by a different entity in the future, the insurance policy is automatically transferred with the loan thereby removing collateral risk and facilitating accurate pricing.

(c) How is the Risk Assessed?

The instant invention is a unique business model allowing the instant analysis of the property sales transaction to assess whether an insurer can assume the risk in using the negotiated sales price as the property's market value. If so, no property appraisal, such as the physical appraisals currently used with their respective shortcomings, is needed.

A decision to insure the risk in using the sales transaction price as the value in the bank's loan to value calculation is based on an instant computer analysis of the following factors on a loan-by-loan basis:
1. The credit worthiness of the applicant or borrower,
2. The amount of cash the applicant or borrower is putting into the property,
3. The size of the loan requested, and
4. The sales transaction price (the “Agreed Sale Price”).

To assess the sales transaction price for a single property, the instant invention's method acquires the value opinions of multiple AVM providers. The instant invention uses a mean average of these values to develop what is known as the AVMerge Value. This AVMerge Value is then assigned an AVMerge Index based on the AVMs selected. The AVMerge Value and its associated AVMerge Index are not designed to reproduce a property's value, but rather to measure the inherent risk in the property's sale price as a reflection of true market value at the time of the transaction. If the risk is acceptable, with use of the instant invention, a certification may be issued called the Transaction Assurance Policy (“TAP”) that is accepted as a basis for issuing an insurance policy on the loan. The negotiated sales price now becomes the value for the bank's loan-to-value calculations.

AVMerge, with its associated value and index, is a part of the overall risk assessment strategy for any given real estate sales transaction. When deciding to approve and/or issue the TAP, additional risk factors may be considered including credit score, sales price (or stated value), loan size, down payment amount (or loan to value for refinances) and property type. In some cases the TAP may be declined (e.g., low credit score), without ever calculating the AVMerge Value.

(d) AVM Variance and the AVMerge Index

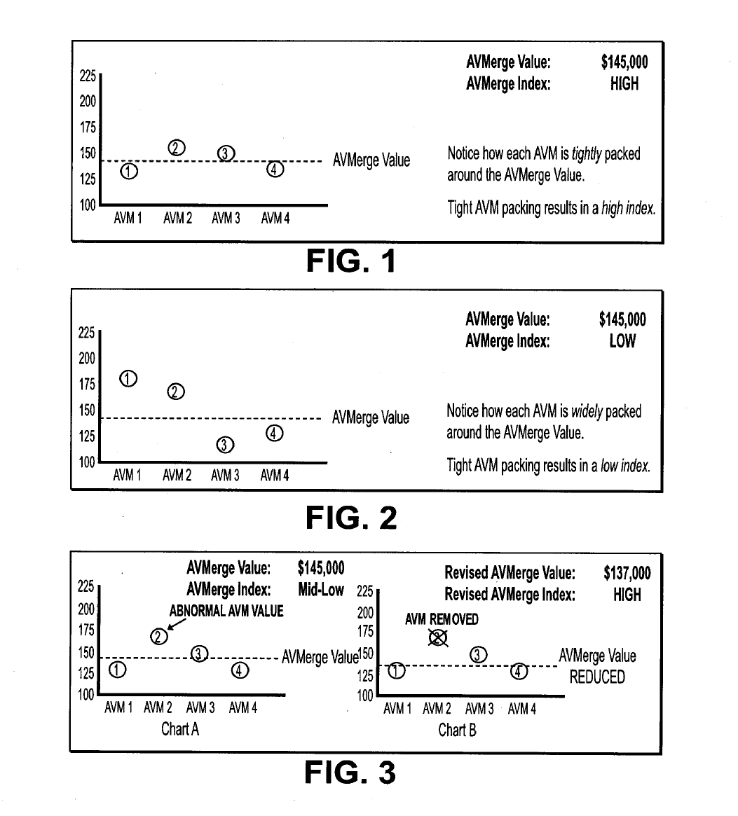

The mean average of multiple AVM sources produces the AVMerge Value. The AVMerge Index provides a numerical relationship of the variance of the AVM sources used to calculate the AVMerge Value. This relationship may be termed AVM Packing as used in the instant invention. The tighter the AVM Packing around the AVMerge Value, the higher the AVMerge Index, i.e., tight AVM Packing results in a high AVMerge Index. A wider AVM Packing produces a lower AVMerge Index, i.e., wide AVM Packing results in a low AVMerge Index. These principles are illustrated in FIGS. 1 and 2.

Software examines the value calculated by each AVM source and determines if any one value exceeds a predefined tolerance of acceptable variance from the AVMerge Value. This principal is illustrated in Chart A in FIG. 3. When this situation occurs, the abnormal AVM value is removed from the AVMerge Value calculation and a revised AVMerge Value is calculated using, for example, the three remaining, tightly packed AVM sources. The result is a modified AVMerge Value (lower in this case), with a high AVMerge Index. This principle is illustrated in Chart B in FIG. 3.

(e) Self-Correcting Value Assessment Model

Using multiple AVM sources provides a value assessment methodology that contains a unique self-correcting strategy. This is highly desired in the potentially subjective field of calculating the value of residential real estate. Multiple AVM providers provide multiple, non-biased value opinions on a single property. By measuring the variance and standard deviations of each provider from the mean average of all sources, an accurate estimate of value can be mathematically determined for use in the invention. Further, the relationship of each value to the group as a whole identifies erroneous values, as well as portrays the overall confidence (AVMerge Index) determined by the instant invention in the resulting average (AVMerge Value).

Over time, data can be collected on variances and deviations to determine expected results and establish predefined tolerances. Thus, an AVM provider cannot suddenly alter its valuation formula, or otherwise deliver an inaccurate valuation without the unexpected result getting quarantined and removed from the instant invention's risk assessment calculations. The instant invention's unique AVM assessment using multiple models works as a self-correcting accuracy gauge that grows increasingly more accurate during continued operation of the instant invention.

The instant invention's ability to instantly assess market value using multiple AVMs, determine accuracy by examining standard deviations, and use the overall result as a factor in assessing risk in the property sales price is a unique business methodology currently desired in the mortgage lending market. As described herein, use of the instant invention can replace the formerly subjective opinion of value with an insurance policy that guarantees that the transaction price is the correct market value for the collateralized property. It removes risk for the ultimate loan purchaser, allows lenders to fund more loans in less time, and helps borrowers buy more homes because the price they negotiate can be used in their lenders loan to value calculations.

(f) Flow Charts Illustrating Embodiments of the Invention

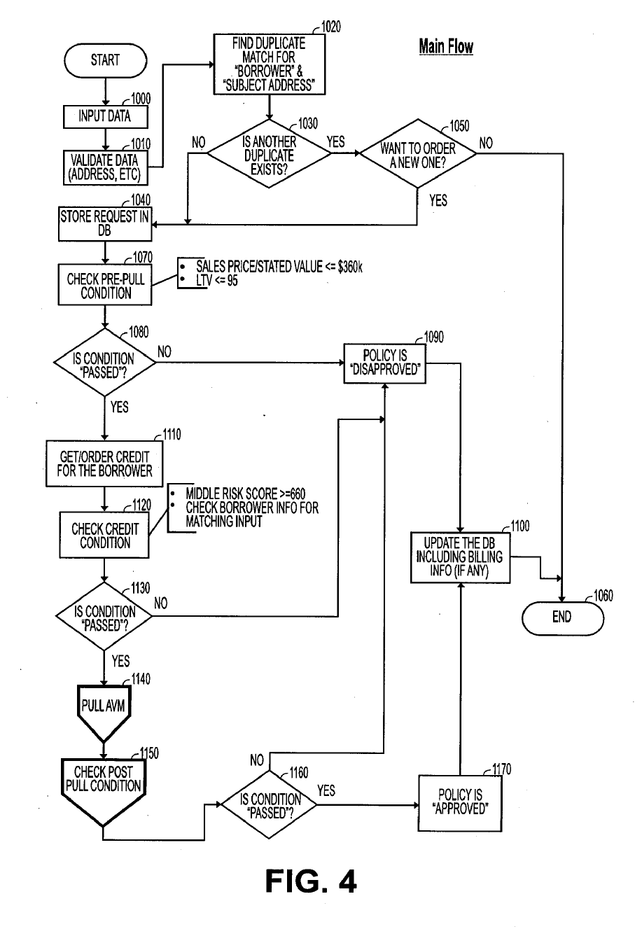

The following discussion of the flowcharts in FIGS. 4 through 9 illustrates some of the principles of the method of the instant invention. The flowcharts and accompanying discussion below are intended to help illustrate various embodiments and portions of the embodiments of the instant invention, without limiting the invention to the described method steps.

(i) An Overview of One Embodiment of the Invention

An embodiment of business method of the invention is depicted in FIG. 4. In some embodiments of the method of the invention all of the steps depicted and described below are used. In other embodiments, more, fewer or substantially fewer than the steps depicted in the Figure and described below are used. As shown in FIG. 4, data concerning the buyer, the seller, and the property to be purchased is input at 1000. Each piece of property must be uniquely identified, usually by one of, or preferably all of, its street, city, state, and country address, although other forms of identifying property known to those of skill in the art may be used. This data includes the credit worthiness of the applicant or borrower, the amount of cash the applicant or borrower is able to put into the purchase of the property, the size of the loan requested, and the Agreed Sale Price. Also at this stage, the Proximity Percentage and Approval Rating (see below for a detailed explanation of these terms) are preferably input. If the invention is to be used with a refinancing of a property, then the proposed valuation of the property by the current owner may be used in lieu of the Agreed Sale Price.

The input device is connected to a computer system with access to information via any means known to one of skill in the art, such as the Internet and internal databases, to validate the data; this step of the method preferably includes confirming and validating the address of the buyer and existence of the property 1010. The internal database (“database” or “DB”) is searched for a duplicate of either the buyer or the property to be financed 1020. If no duplicate exists 1030, the new request is stored in the database 1040. If the borrower and/or the property to be financed are present in the database 1030, then the operator inputs a decision whether to conduct a new analysis 1050: if not, the transaction terminates 1060; if the decision is to proceed, the instant invention stores a request for a new analysis in the database 1040.

Whether the transaction qualifies for further analysis is verified by reviewing the loan-to-value (LTV) ratio, and whether the loan size falls within the preset tolerance limits for sales price and property type 1070. As but one non-limiting example, with reference to FIG. 4, the LTV may be set to less than or equal to 95, and the sales price or stated value may be set to less than or equal to $360,000. The values can be set by the user of the instant invention. The available information in the database is reviewed to determine if this transaction may proceed past this checkpoint 1080; if yes, proceed 1110, if not, the policy is declined or “disapproved” 1090 and the transaction terminates. If the policy is disapproved, update the database to include billing information 1100, then end the transaction 1060.

If the transaction passes the checkpoint 1080, credit scores for the borrower(s) are obtained. If the banker or the lender has a recent credit report on file, this may be used and imported into the database; otherwise a new credit report may be ordered 1100. In a preferred embodiment, the recent credit report used is less than 30 days old. The credit rating is reviewed 1120 to ensure scores meet predefined tolerance limits. In preferred embodiments, the credit score is greater than or equal to 660. In other embodiments, the credit rating to be used is taken from a computer database where current lender or insurer acceptance values are stored.

If the credit rating meets predefined tolerance criteria 1130, the transaction continues 1140, or, if the credit rating does not pass, the policy is disapproved 1090. If the policy is disapproved, update the DB to include billing information at 1100, then end the transaction at 1060.

(ii) Pull AVM Protocol

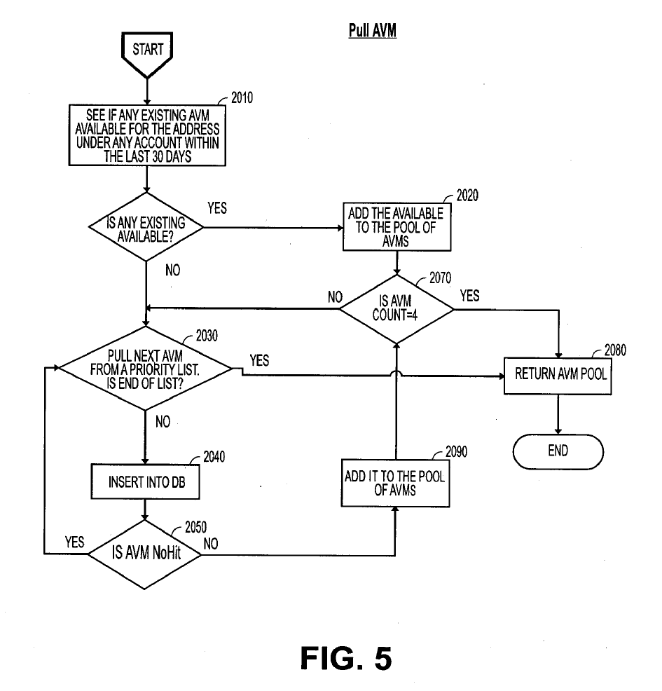

Reference is again made to FIG. 4. In some embodiments of the method of the invention, if the transaction continues from 1130 as described above, the transaction is analyzed further via a Pull AVM protocol 1150. One example of such a Pull AVM protocol is illustrated in the embodiment in FIG. 5. In one such embodiment, and with reference to FIG. 5, a database used with the instant invention is searched for existing AVMs for this address of the property to be purchased at 2010. In a preferred embodiment, if any AVMs obtained and stored in the database of the instant invention in the 30 days prior to the search are available, these AVM Values will be taken for the AVM 2020.

AVMs are pulled from the available library of AVM products until a pool (preferably a group of zero to four AVMs for a given property address) is achieved. In preferred embodiments, the total AVMs to be used is set at four, although one of skill in the art using the invention will recognize that a different number, such as 3, 6, or 8 may be used, four is preferred. In one embodiment, for example at 2070 in FIG. 5, the required pool is set at values obtained from four AVM products. In other preferred embodiments, 6, 7, 8, 9, or 10 vendors' AVM products are available. In another preferred embodiment, 10 vendors' AVM products are available. Note that frequently ancillary data accompanies the AVM purchased from a vendor; preferably only the AVM values are used and ancillary data is discarded.

Any reliable source of AVMs may be used with the method of the invention. For example, some of the available sources of AVMs from the pool of AVMs that are available for use in methods of the instant invention are listed below.

| AVM | Vendor |
|---|---|
| VeroVALUE | Veros Software (Santa Ana, CA.) |
| PowerBASE^{SM} | First American Real Estate Solutions |
| Home Price Analyzer (HPA^{SM}) | First American Real Estate Solutions |
| PASS | First American Real Estate Solutions |
| | (Anaheim, CA) |
| ValueFinder ™ | LandSafe (Plano, TX) |
| ValueWizard ™ | TransUnion (Chicago, IL) |
| PSARez | PSAR Systems (Calistoga, CA) |
| CASA ® | Fiserv CSW (Cambridge, MA) |
| AVMax | R J Peters Associates, Inc. |
| | (Colchester, VT) |
| SiteX Value | Fidelity Information Services |
| | (Jacksonville, FL) |
| HVE ® via CSC | (Freddie Mac, McLean, Va.). |

As noted above, other automated systems for determining real property values may be used by the instant invention, irrespective of whether they are called AVMs.

As part of the Pull AVM step, the property address is entered into the database and compared to the existing library of AVMs ranked by a pre-established system. In a preferred embodiment, this information is obtained from the computer system or database at 1000 or 1010. Also, in a preferred embodiment of the instant invention, the AVMs are ranked according to price, with the less expensive AVMs to be used prior to the higher-priced AVMs. An AVM is pulled from the top ranked AVM product in the list 2030 (e.g., in one arrangement the least expensive AVM) and inserted into the database 2040. If the last AVM selected was the last entry on the list of available AVM products and no more are available, the current AVM pool is returned 2080; this pool may contain, in a preferred embodiment and as illustrated in FIG. 5, zero to four AVM values. AVM values preferably are accepted regardless of any qualifying confidence score or any other conditions or qualifications. In one embodiment, the AVMs are sorted before selection in order of price to the operator of the instant invention with AVMs selected from lowest price to highest price.

If an AVM selected 2030 and inserted into the database 2040, and the selected AVM cannot produce a value associated with the subject property (a “no-hit”) 2050, the next AVM on the sorted list is selected at 2030. If an AVM value is returned, it is added to the pool of AVMs 2090. If four AVMs have been obtained 2070, the AVM pool is returned to the database 2080 as a successful search. (Return to 1140.)

(iii) Determination of AVMs

In preferred embodiments of the invention and as described above, AVMs are obtained from commercial vendors by means known in the art. One of skill in the art will understand that each AVM vendor uses its own independent algorithm(s) to obtain an AVM value. Each AVM provider may be calibrated for the accuracy of their determination of AVMs over time; AVM providers that are not accurate or do not meet predetermined criteria are preferably dropped as a source.

If AVM vendors are to be calibrated, this is preferably done every calendar quarter. In this case, AVM vendors are calibrated on the basis of previously funded loans; for example, a number of loans between 0 and 100,000 are compared by (1) the AVM values obtained for the address that is the subject of a loan, and (2) the actual purchase price. The number of loans compared may also be about 5,000, about 10,000, about 20,000, or any number within this range.

(iv) Post Pull Protocol

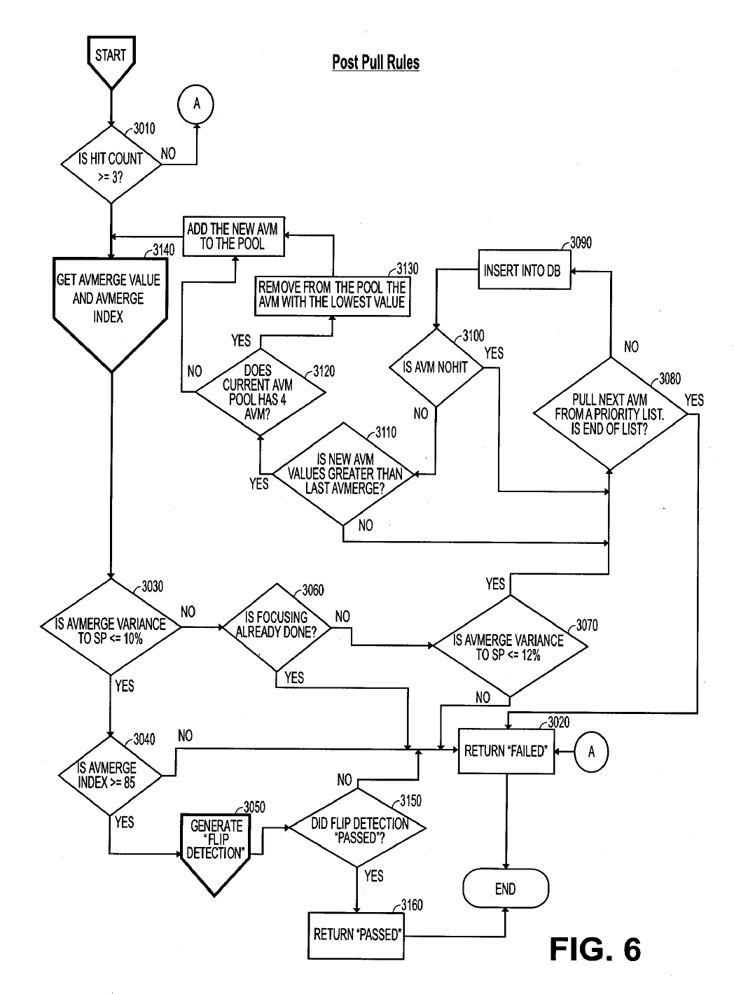

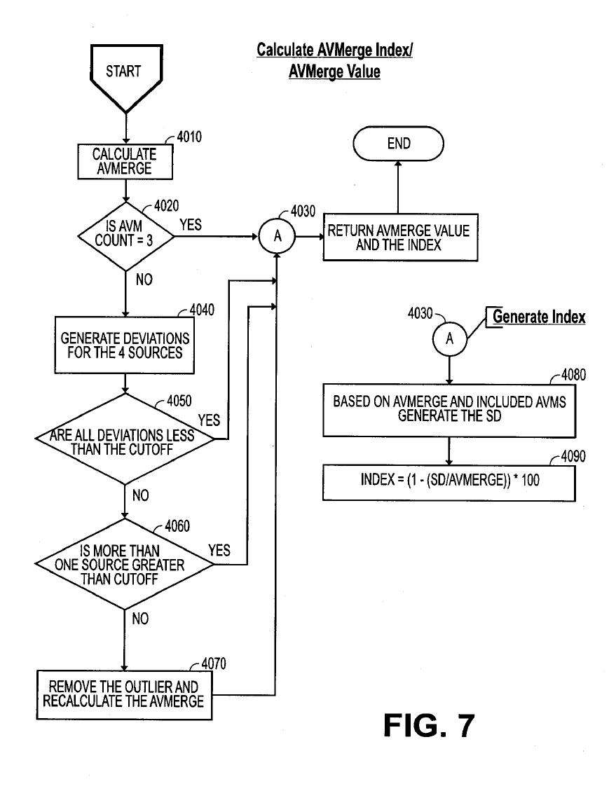

After the AVMs have been returned to the database as referenced at 1140 in FIG. 4, a Post Pull analysis 1150 may be conducted in a preferred variation of the invention. One such embodiment is further illustrated in FIG. 6, where in this example of a Post Pull analysis, the number of AVMs is first confirmed as being, for example, at least three AVMs 3010. In this preferred embodiment, if there are not at least three AVMs, the instant invention fails to return an approved policy validating the transaction price or Agreed Sales Price 3020 (via “A” from upper left to lower right of FIG. 4). If there are three or more AVM values, the AVMerge Value and AVMerge Index are calculated as 3140 in FIG. 6 as well as 4010 in FIG. 7.

The detailed process of a preferred AVMerge Value and AVMerge Index calculation, as well as Outlier Analysis, is depicted in FIG. 7 and described as follows. The mean of the selected AVMs is first taken as the AVMerge Value 4010. If the AVM count is three 4020, generate the AVMerge Index, conclude the Outlier Analysis without further steps 4030 and use the first calculated AVMerge Value and calculate the AVMerge Index 4080 and 4090. In this case, with only three AVMs, the Outlier Analysis is deemed concluded without further analysis.

(v) Outlier Analysis

An overview of the Outlier Analysis process may be understood with the example as depicted in FIGS. 1 through 3. In FIG. 1, the AVM Values are clustered near the AVMerge Value and the cutoff value (set relative to standard deviations) is not used. In FIG. 2, three of the four AVM values are clustered near the AVMerge Value. In other examples (not shown), only two, one, or none of the AVM Values are near the AVMerge Value. This clustering will be reflected in the AVMerge Index. In some cases with use of the invention one value may exceed a predefined tolerance of acceptable variance from the AVMerge Value as illustrated in Chart A in FIG. 3. In this case, the abnormal AVM value is removed from the AVMerge calculation and a revised AVMerge Value is calculated resulting is a modified AVMerge Value (lower in this particular example), with a high AVMerge Index as illustrated in Chart B in FIG. 3. In other circumstances, two or more AVMs may be found to have such abnormal AVM Values, especially when a higher number of AVMs is used, such as 6, 8, or 10.

Reference is again made to FIG. 7. In greater detail, the Outlier Analysis may be conducted as follows. As discussed supra, if the AVM count is three 4020, generate the AVMerge Index, conclude the Outlier Analysis without further steps 4030 and use the first calculated AVMerge Value and calculate the AVMerge Index 4080 and 4090.

In this example of one embodiment of the invention, if the AVM count is not three, then it is four, and Outlier Analysis is performed as follows (in other words, in this embodiment, Outlier Analysis requires a minimum of four AVMs). Standard deviations are calculated for all four sources 4040. If all the deviations are less than the Cutoff (see infra) 4050, generate an AVMerge Index 4030, then conclude the Outlier Analysis without further steps, and the first calculated AVMerge Value is used. If all the deviations are not less than the Cutoff, check the number of AVM values greater than the cutoff 4060 using the methods of the invention. If there is only one AVM value 4070, remove this AVM above the cutoff, also known as the “Outlier,” and recalculate the AVMerge Value; followed by recalculating the AVMerge Index 4070, and return 4030. In this embodiment, the Outlier Analysis is concluded 4030.

If, on the other hand, more than one AVM source is greater than the cutoff 4060, conclude the Outlier Analysis 4030 and return the AVMerge Value 4030.

Following conclusion of the Outlier Analysis described in one embodiment as 4010, 4020, 4040, 4050, 4060, 4070 in FIG. 7, the AVMerge Index is calculated by taking the standard deviation 4080 divided by the AVMerge price, subtracting that value from one and multiplying by 100 4090.

(vi) The Cutoff Value for Outlier Analysis

In preferred embodiments, the cutoff is a standard deviation of more than about 1.5. Other values of the cutoff, such as 1, about 1, 1.2, about 1.2, 1.4, about 1.4, 1.6, about 1.6, 1.8, about 1.8, 2, about 2.2, about 2.2, 2.5, and about 2.5, are also encompassed by the instant invention.

Other statistical means for calculating deviations from a mean known to those of skill in the art may also be used, and equivalent values for cutoffs may be used instead of the above values for standard deviation analysis. Such means include standard curve-fitting analyses, e.g., least-squares analysis.

In a preferred embodiment of the invention, the cutoff value is calibrated up to four times per year using a list of 2000 (or more) property addresses within 30 days of loan closing, optionally including both property sales and refinancing. All address listings contain the Agreed Sale Price, and/or the loan amount plus equity for refinancings, and (if possible) any associated value opinion or appraisal. All AVMs in the list are run against the same list of property addresses to measure standard deviations of the AVM values returned for each address. The invention thus also allows for instant assessment of modifications to the cutoff value.

(vii) Proximity Percentage and Approval Rating

With reference again to FIG. 6, if both the AVMerge Value is within a user-set percentage of the Agreed Sale Price (hereinafter known as the Proximity Percentage), for example, within 10% of the Agreed Sale Price 3030, and the AVMerge Index is greater than or equal to a user-set value (hereinafter known as the Approval Rating) 3040, then the policy is preliminarily approved.

In preferred embodiments of the invention the Proximity Percentage is 10% of the Agreed Sale Price; thus, the AVMerge Value is within 10% of the Agreed Sale Price as illustrated at 3030 in FIG. 6. In other embodiments, the Proximity Percentage is, for example, within 30%, 20%, 18%, 17%, 16%, 15%, 14%, 13%, 12%, 9%, 8%, 7%, 6%, 5%, 4%, or 3% of the Agreed Sale Price. In preferred embodiments of the invention, policies will only be approved when the Approval Rating value of the AVMerge Index is about 85 or higher, as illustrated at 3040 in FIG. 6. In other embodiments, the Approval Rating value of the AVMerge Index is set at one of the following values (where the stated value is the lower limit) 80, about 80, 82, about 82, 84, about 84, about 85, 86, about 86, 87, 88, about 88, 89, 90, about 90, 92, or about 92.

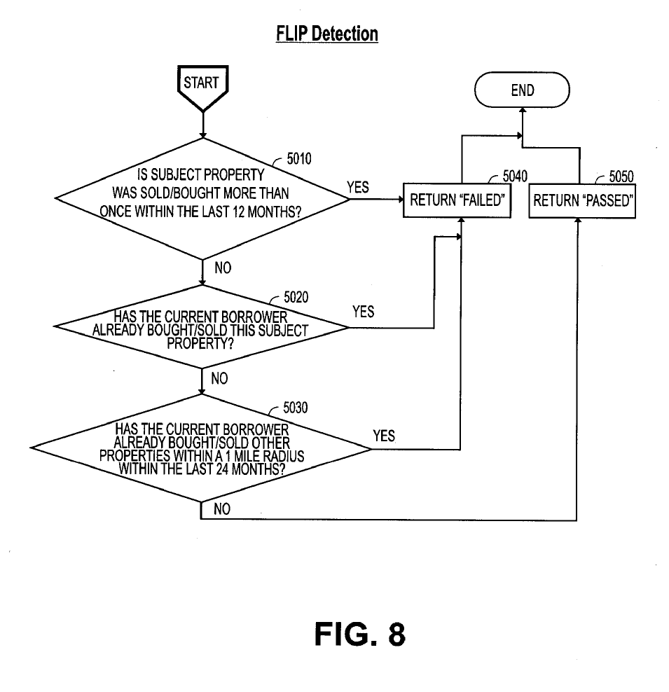

Preferably all potentially successful transactions are subjected to Flip Detection in the use of the method of the instant invention illustrated at 3050 in FIG. 6 and in greater detail at 5010 in FIG. 8. If the transaction passes the Flip Detection, as illustrated at 3150 in FIG. 6, the transaction is passed 3160, and the subroutine ends; if the transaction does not pass the Flip Detection 3150, the transaction fails 3020.

If the AVMerge Value is greater than or equal to the Proximity Percentage of the Agreed Sale Price, and the AVMerge Index is less than the Approval Rating value 3040, the instant invention fails to return a positive result with regard to approving and/or issuing a policy to validate the Agreed Sales Price 3020 (i.e., approving and/or issuing a TAP) and the transaction ends.

If, however, the policy is not approvable at this point because the AVMerge Value is not within the Proximity Percentage of the Agreed Sale Price, a full Post-Pull analysis may be conducted at 1160, for example, in one embodiment of the invention illustrated in FIG. 6.

(viii) Focusing

An optional, yet important, part of the Post Pull analysis is referred to herein as Focusing with reference again to one embodiment of the invention as illustrated in FIG. 6, a transaction is reviewed to see if focusing is already done 3060. If yes, the transaction is terminated 3020.

If the AVMerge Value is not within the Proximity Percentage of the Agreed Sale Price 3030, but the AVMerge Value is within the (Proximity Percentage−X) of the Agreed Sale Price, a Post-Pull focusing analysis may be 3060 performed and may allow successfully approving and/or issuing a TAP. Preferred values of X are 1%, about 1%, 2%, and about 2% 3070.

In an example of Focusing Analysis, as illustrated in FIG. 6, the sorted list of AVMs is consulted, the next AVM Value is selected 3080, then inserted into the database 3090. If the AVM is a no-hit result 3100 (i.e., the AVM vendor fails to return an AVM for the property in question), the instant invention returns to the sorted AVM list and selects the next value 3080 for insertion into the database 3090, and the check for a no-hit 3100 repeats. If a valid AVM is available, the new AVM is compared to the previous AVMerge Value 3110. If the new AVM value is less than the former AVMerge Value 3110, the selection of a new AVM is repeated 3080 until no more sorted AVMs are available, at which point the transaction fails 3020. If the new AVM is greater than the last AVMerge Value 3110, the current pool is checked to see if it has four AVM values 3120 as illustrated in FIG. 6. If yes, the lowest AVM value is dropped 3130, if not, the new AVM is added to the pool 3130, and the AVMerge and AVMerge Index is calculated afresh 3140 and, in some embodiments, as illustrated in greater detail in FIG. 7, and the process continues.

(ix) Calculate AVMerge Index/AVMerge Value

In preferred embodiments of the instant invention, the buyer and seller have agreed to buy a home and sell a home at a certain price, the Agreed Sale Price. The Agreed Sale Price is compared to the AVMerge Value as calculated supra (in one example, see 3030 and 3040 in FIG. 6). If the AVMerge Value is within the Proximity Percentage of the agreed purchase price the value Agreed Sale Price is deemed insurable, and a TAP may be approved and/or issued. For example, if the AVMerge Value is $90,000, the Proximity Percentage of the Agreed Sale Price is 10%, and the agreed purchase value is $100,000, the value of the home is established at $100,000.

(g) Flip Analysis

Flipping is a practice whereby a buyer rapidly buys and sells property. Although not, in and of itself, fraudulent, unscrupulous ‘flippers’ can enlist the services of a colluding appraiser to obtain inflated property values or enlist a confederate to purchase a property at an inflated value and then default on the loan. Although the use of the instant invention may circumvent the possibility of an unscrupulous appraiser, one of skill in the art will no doubt recognize that there are other ways to obtain a fraudulent advantage in flipping properties/mortgages that are not directly addressed by the methods of the invention.

However, in some embodiments of the invention, to avoid the predations of unscrupulous flippers, the transaction is subjected to a Flip Detection Analysis, one embodiment of which is depicted in FIG. 8. In this embodiment, use of the instant invention checks the title to see if the subject property was sold more than, for example, preferably once in the prior twelve months 5010, although different conditions may be set, for example, more than once in the prior eighteen, nine or six months. In the preferred embodiment illustrated in FIG. 8, if the property has been sold/bought more than once in the past year, the transaction and loan insurance policy is declined 5040. If the property has not been bought/sold more than once in the past year, the analysis determines whether the current prospective borrower has bought/sold the subject property before the instant transaction 5020. If the current prospective borrower has already bought/sold the subject property, then the subject transaction and loan insurance policy in one embodiment is declined 5040. Finally, the transaction may be checked as to whether the current prospective borrower has bought/sold other real properties within a one mile radius of the prospective purchase within the last 24 months 5030. If the current prospective borrower has bought/sold other real properties within, for example, a one mile radius of the prospective purchase within the last, for example, 24 months, the subject transaction and loan insurance policy is declined 5040. If the instant transaction has not failed the Flip Detection up until now, the transaction passes the Flip Detection process 5050 and may proceed. One of skill in the art will recognize that different values may be set for the above parameters, the values above are preferred values for a metropolitan area. For example, a 0.2, 0.5, 2, 5 or 10 mile or more radius may be used at 5030. Generally, a smaller radius is used in more heavily populated areas, and larger radii used in less populated areas. Similarly, a value of less than 24 months, such as six, nine, twelve or more than 24 months, such as 30, 36 or 48 or more may be used at 5030.

(h) Conclusion:

If, based on the criteria and the methods of the instant invention as described above, the Transaction Assurance Policy (“TAP”) is approvable, thus an insurance policy on the loan is approved, may be approved, is issued and/or may be issued, and the bank does not need an appraisal. (For example, see, 3160 in FIG. 6). In other embodiments, the instant invention may be used for direct approval of the loans, and the loan may be approved, funded, or authorized for funding at this point.

(i) TAP Activation Process

The buyer of the services of the instant invention may be offered a choice and may order/purchase a TAP certificate in two steps. First, the customer may order a pre-qualification decision, called a First Look. In a First Look analysis, the full TAP analysis is conducted using all the necessary data and a decision is generated on the computer/database/program but a TAP is not issued. (For example, when a transaction is passed at 3160 (FIG. 6), a TAP may be issued instantly by the appropriate vendor or the user of the instant invention.) Although providing a First Look is a preferred embodiment of the invention, the method of the invention may be used without the First Look component.

Based on the First Look analysis, a yes/no answer is returned, and, if the computer/database/program approves the TAP, the First Look analysis is assigned a TAP designation, for example, a number. Subsequently, the customer may purchase, or activate, the First Look analysis and this analysis is converted into a TAP Certificate using the same TAP number.

Any prospective lender or borrower may order a First Look to learn if a given prospective loan qualifies for a TAP. If so, a minimal price is charged immediately to the inquiring lender or borrower for the First Look information. In some embodiments, the minimal price is $25. In other embodiments, the minimal price is about 10%, about 12.5%, about 15%, or about 20% or more of the overall or final price of the TAP analysis as described herein. The First Look is then assigned a TAP designation, for example, a TAP Number for future use in loan tracking. Once the loan closes, the TAP number can be used to activate the insurance policy for an additional charge. In some embodiments, the price for activation is less than or $175, $200, $250, $300 or more. In other embodiments, the minimal price is about 80%, about 85%, about 87.5%, or about 90% of the overall price.

In this preferred embodiment, the Activation process reduces the costs for prospective lenders. Without the First Look/Activation process, the prospective lender may buy a TAP certificate for the full price, e.g., in a non-limiting example, $200, only to have the loan fail to close. The First Look/TAP-activation aspect of the instant invention enables an immediate TAP qualification decision at a very low cost. There are no charges incurred, other than the cost charged for the First Look, if the TAP is not approved for the loan. Thus, most of the cost for the TAP certificate is incurred only for loans that actually close.

The result is that a lender using the First Look/TAP-activation aspect of the instant invention has a better predictability of total loan costs because the activation cost is only incurred when the loan closes. This allows the lender to better control costs and decide (for example, from a marketing perspective), if it is beneficial to absorb the costs in regard to its earnings per loan, and pass the savings along to the borrower in the way of lower loan fees. Alternative appraisal methods do not work as well in this regard since they must be paid in full during underwriting—even though the loan may not close.

(j) Two Methods of Activation

Activation is the process of converting a First Look analysis present within a Lender's account into active TAP Certificates in the embodiment of the method of the present invention where a First Look component is used. This activation may done either manually with human intervention, or via a computer or the Internet, or a combination of methods.

Since activating a First Look effectively substantially increases the charges, activation is preferably completed after the loan is closed, or as close to the closing as possible. This timing eliminates the financial loss incurred by activating First Looks for loans that fail to close.

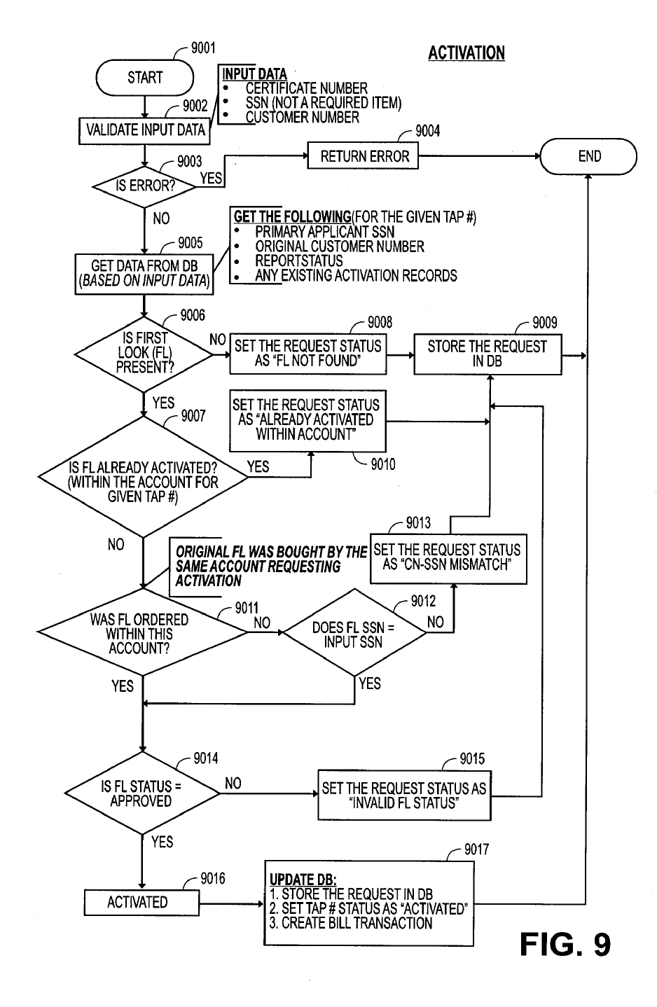

Two examples of the activation process are as follows, and are described with reference to FIG. 9; variations of these processes will be made by one of skill in the art within the scope of the present invention to fit the needs of the particular loan transaction(s) or lender(s).

Manual Activation: A lender seeking to activate a First Look can search by a variety of loan criteria including, but not limited to: loan identification number, social security number of a party, date range, TAP designation or Number, property address and names of any of the parties, 9001. To activate the user simply selects the appropriate First Look(s), for example using a check box, and orders the computer to activate it.

Automatic Activation: The lender for example, and preferably using a web services application, simply uploads the TAP numbers and social security numbers for all loans that have been closed (i.e., funded) that have First Looks where activation is required, 9001. Each First Look is automatically activated and recorded as such 9017.

Further, and with reference to FIG. 9, the input data used to begin the process is validated 9002 and if there is an error in the input data 9003 the computer/database/program returns the error 9004 and ends the process. The input data at 9002 may include information useful for one of skill in the art in the activation process. Preferably, such information includes the TAP certificate number, social security number of the loan applicant (i.e., the borrower) and/or the customer number. If the input data is valid, the computer/database/program uses the input data to generate the TAP file which includes the Report Status, listing the date it was obtained, and any record of an earlier activation of the account, and other information 9005.

If the file does not include a reference to a First Look being requested 9006, then the computer/database/program notes that a First Look is not found 9008, the request is stored in the computer/database/program 9009 and the activation process ends without activation. If the file, on the other hand, includes a reference to a First Look 9006, the computer/database/program checks to see if the First Look has already been activated within the account for a given TAP designation number 9007. If the account has already been activated, the redundant request is noted 9010 and stored in the computer/database/program 9009.

If the First Look was not already activated according to this embodiment of the invention, it is queried whether the First Look was already ordered within the account 9011. If not, it is queried whether the Social Security Number (SSN) associated with the First Look within the system matches the input Social Security Number 9012. If not, set the request status as “CN-SSN mismatch” in the database 9013 and store the request in the database 9009. If it does match, check to see if the First Look was approved 9014. Also, check to see if the First Look was already ordered within the account 9011, check to see if the First Look was approved 9014. In either of these inputs to question 9014, if the First Look was not approved, set the request status as “Invalid First Look Status” 9015 and store the request in the computer/database/program 9009. If at the 9014 check the First Look status was approved, then activate the First Look 9016 and update the database 9017. Examples of actions that may be taken in updating the database 9017 include storing the request in the database, setting the TAP designation or number status as “Activated” and/or creating a bill transaction.

Preferably, First Looks are activated within a specific time after its original order date. Most preferably, a First Look must be activated no later than 120 days after its original order date.

(k) Examples of How Loan Brokers May Submit Requests for First Looks

In embodiments of the invention that include a First Look component, loan brokers may desire to order a First Look before selecting a specific lender. If multiple lenders accept TAP Certificates in place of appraisals, knowing if the loan qualifies for TAP helps the broker choose the best loan program. It also helps the broker communicate lower fees to the consumer since issuing a TAP is less expensive than traditional appraisals.

When the broker submits a loan request and/or application to a lender, he/she may include a First Look along with its associated TAP designation or number. The lender then records this TAP designation or number into its system so that it can be activated if and when the loan closes. Once the loan closes, the submitted TAP designation or number is activated in the normal process.

In another embodiment of the invention, the broker may submit the loan request and/or application and First Look to one lender, and optionally submit the same loan request and/or application and First Look to additional lenders at a later date, all associated with the same TAP designation or number. Should different lender's activate the same TAP designation or number, the instant invention preferably is able to recognize this situation and preferably for reasons of efficiency, ensure that only one TAP policy is ordered/certified for a given loan, even though multiple TAP certificates were ordered.

(l) An Overview an Embodiment Using the Invention for Refinancing

An embodiment of business method of the invention is depicted in FIG. 4. As described supra, the invention may be used to obtain a loan for purchasing property. Many of the same methods of the instant invention may also be used to refinance. In some embodiments of the method of the invention all of the steps depicted and described below are used. In other embodiments, more, fewer or substantially fewer than the steps depicted in the Figure and described below are used. Although FIG. 4 was originally used to describe obtaining a loan for the purchase of a house, it can also be used in reference to describe the steps of using a method of the instant invention to refinance property. Thus, as a first step, data concerning the person desiring to refinance, i.e., borrower, and the property to be refinanced is input at 1000. Each piece of property must be uniquely identified, usually by one of, or preferably all of, its street, city, state, and country address, although other forms of identifying property known to those of skill in the art may be used. This data includes the credit worthiness of the borrower, the amount of cash the borrower is able to put into the refinance of the property, the size of the loan requested, and the amount of equity the borrower has in the property. Also at this stage, the refinance Proximity Percentage and Approval Rating (see elsewhere herein for a detailed explanation of these terms) are preferably input. In some aspects or embodiments of the invention, the method of the invention is used in a refinance to determine, and preferably obtain, a size of the loan the borrower is eligible for in the refinance. Thus in some embodiments of the invention, at 1000, there is no input for size of loan requested, as the invention may be used to determine the size of the loan, or a range of sizes for proposed loan. In a preferred aspect of the invention, the method of the invention is used to determine the maximum loan size available to the borrower in the refinance. In one embodiment of the instant invention the maximum loan size available with or without a TAP for a given borrower and property is determined. In other embodiments of the invention, a range of loans or loan sizes available with or without a TAP for a given borrower and property is determined. Thus, in some of the above aspects and embodiments of the instant invention, a determination is made for the maximum loan size for refinance, or a range of loan sizes, and preferably provided to the borrower. Preferably, the maximum loan size or range of loan sizes are the maximum loan size or range of loan sizes available with a TAP for a given borrower and property.

The input device is connected to a computer system with access to information via any means known to one of skill in the art, such as the Internet and internal databases, to validate the data; this step of the method preferably includes confirming and validating the address of the buyer and existence of the property 1010. The internal database (“database” or “DB”) is searched for a duplicate of either the buyer or the property to be financed 1020. If no duplicate exists 1030, the new request is stored in the database 1040. If the borrower and/or the property to be financed are present in the database 1030, then the operator inputs a decision whether to conduct a new analysis 1050: if not, the transaction terminates 1060; if the decision is to proceed, the instant invention stores a request for a new analysis in the database 1040.

Whether the transaction qualifies for further analysis is verified by reviewing the loan-to-value (LTV) ratio as set by the insurer and/or lender, and whether the loan size falls within the preset tolerance limits for the property type and maximum loan size 1070. As but one non-limiting example, with reference to FIG. 4, the LTV may be set to less than or equal to 95, and the maximum value of loan-plus-equity may be set to less than or equal to $360,000. The values can be set by the user of the instant invention. The available information in the database is reviewed to determine if this transaction may proceed past this checkpoint 1080; if yes, proceed 1110, if not, the policy is declined or “disapproved” 1090 and the transaction terminates. If the policy is disapproved, update the database to include billing information 1100, then end the transaction 1060.

If the transaction passes the checkpoint 1080, credit scores for the borrower(s) are obtained. If the banker or the lender has a recent credit report on file, this may be used and imported into the database; otherwise a new credit report may be ordered 1100. In a preferred embodiment, the recent credit report used is less than 30 days old. The credit rating is reviewed 1120 to ensure scores meet predefined tolerance limits of the lender and/or insurer. In preferred embodiments, the credit score is greater than or equal to 660. In other embodiments, the credit rating to be used is taken from a computer database where current lender or insurer acceptance values are stored.

If the credit rating meets predefined tolerance criteria 1130, the transaction continues 1140, or, if the credit rating does not pass, the policy is disapproved 1090. If the policy is disapproved, update the DB to include billing information at 1100, then end the transaction at 1060.

(i) Pull AVM Protocol

Reference is again made to FIG. 4. In some embodiments of a method of the invention, if the transaction continues from 1130 as described above, the transaction is analyzed further via a Pull AVM protocol 1150. One example of such a Pull AVM protocol is illustrated in the embodiment in FIG. 5. In one such embodiment, and with reference to FIG. 5, a database used with the instant invention is searched for existing AVMs for this address of the property to be refinanced at 2010. In a preferred embodiment, if any AVMs obtained and stored in the database of the instant invention in the 30 days prior to the search are available, these AVM Values will be taken for the AVM 2020.

AVMs are pulled from the available library of AVM products until a pool (preferably a group of zero to four AVMs for a given property address) is achieved. In preferred embodiments, the total AVMs to be used is set at four, although one of skill in the art using the invention will recognize that a different number, such as 3, 6, or 8 may be used, four is preferred. In one embodiment, for example at 2070 in FIG. 5, the required pool is set at values obtained from four AVM products. In other preferred embodiments, 6, 7, 8, 9, or 10 vendors' AVM products are available. In another preferred embodiment, 10 vendors' AVM products are available. Note that frequently ancillary data accompanies the AVM purchased from a vendor; preferably only the AVM values are used and ancillary data is discarded.

Any reliable source of AVMs may be used with the method of the invention. For example, some of the available sources of AVMs from the pool of AVMs that are available for use in methods of the instant invention are listed below.

| AVM | Vendor |
|---|---|
| VeroVALUE | Veros Software (Santa Ana, CA.) |
| PowerBASE^{SM} | First American Real Estate Solutions |
| Home Price Analyzer (HPA^{SM}) | First American Real Estate Solutions |
| PASS | First American Real Estate Solutions |
| | (Anaheim, CA) |
| ValueFinder ™ | LandSafe (Plano, TX) |
| ValueWizard ™ | TransUnion (Chicago, IL) |
| PSARez | PSAR Systems (Calistoga, CA) |
| CASA ® | Fiserv CSW (Cambridge, MA) |
| AVMax | R J Peters Associates, Inc. |
| | (Colchester, VT) |
| SiteX Value | Fidelity Information Services |
| | (Jacksonville, FL) |
| HVE ® via CSC | (Freddie Mac, McLean, Va.). |

As noted above, other automated systems for determining real property values may be used by the instant invention, irrespective of whether they are called AVMs.

As part of the Pull AVM step, the property address is entered into the database and compared to the existing library of AVMs ranked by a pre-established system. In a preferred embodiment, this information is obtained from the computer system or database at 1000 or 1010. Also, in a preferred embodiment of the instant invention, the AVMs are ranked according to price, with the less expensive AVMs to be used prior to the higher-priced AVMs. An AVM is pulled from the top ranked AVM product in the list 2030 (e.g., the least expensive AVM) and inserted into the database 2040. If the last AVM selected was the last entry on the list of available AVM products and no more are available, the current AVM pool is returned 2080; this pool may contain, in a preferred embodiment and as illustrated in FIG. 5, zero to four AVM values. AVM values preferably are accepted regardless of any qualifying confidence score or any other conditions or qualifications. In one embodiment, the AVMs are sorted in order of price to the operator of the instant invention with AVMs selected from lowest price to highest price.

If an AVM selected 2030 and inserted into the database 2040, and the selected AVM cannot produce a value associated with the subject property (a “no-hit”) 2050, the next AVM on the sorted list is selected at 2030. If an AVM value is returned, it is added to the pool of AVMs 2090. If four AVMs have been obtained 2070, the AVM pool is returned to the database 2080 as a successful search. (Return to 1140.)

(ii) Determination of AVMs

In preferred embodiments of the invention and as described above, AVMs are obtained from commercial vendors by means known in the art. One of skill in the art will understand that each AVM vendor uses its own independent algorithm(s) to obtain an AVM value. Each AVM provider may be calibrated for the accuracy of their determination of AVMs over time; AVM providers that are not accurate or do not meet predetermined criteria are preferably dropped as a source.

If AVM vendors are to be calibrated, this is preferably done every calendar quarter. In this case, AVM vendors are calibrated on the basis of previously funded loans; for example, a number of loans between 0 and 100,000 are compared by (1) the AVM values obtained for the address that is the subject of a loan, and (2) the actual purchase price. The number of loans compared may also be about 5,000, about 10,000, about 20,000, or any number within this range.

(iii) Post Pull Protocol

After the AVMs have been returned to the database as referenced at 1140 in FIG. 4, a Post Pull analysis 1150 may be conducted in a preferred variation of the invention. One such embodiment is further illustrated in FIG. 6, where in this example of a Post Pull analysis, the number of AVMs is first confirmed as being, for example, at least three AVMs 3010. In this preferred embodiment, if there are not at least three AVMs, the instant invention fails to return an approved policy validating the desired loan value price 3020 (via “A” from upper left to lower right of FIG. 4). If there are three or more AVM values, the AVMerge and AVMerge Index are calculated as 3140 in FIG. 6 as well as 4010 in FIG. 7.

The detailed process of a preferred AVMerge Value and AVMerge Index calculation, as well as Outlier Analysis, is depicted in FIG. 7 as follows. The mean of the selected AVMs is first taken as the AVMerge Value 4010. If the AVM count is three 4020, generate the AVMerge Index, conclude the Outlier Analysis without further steps 4030 and use the first calculated AVM Merge Value and calculate the Index 4080 and 4090. In this case, with only three AVMs, the Outlier Analysis is deemed concluded without further analysis.

(iv) Outlier Analysis

An overview of the Outlier Analysis process may be understood with the example as depicted in FIGS. 1 through 3. In FIG. 1, the AVM Values are clustered near the AVMerge Value and the cutoff value (set relative to standard deviations) is not used. In FIG. 2, three of the four AVM values are clustered near the AVMerge Value. In other examples (not shown), only two, one, or none of the AVM Values are near the AVMerge. This clustering will be reflected in the AVMerge Index. In some cases with use of the invention one value may exceed a predefined tolerance of acceptable variance from the AVMerge Value as illustrated in Chart A in FIG. 3. In this case, the abnormal AVM value is removed from the AVMerge calculation and a revised AVMerge Value is calculated resulting is a modified AVMerge Value (lower in this particular example), with a high AVMerge Index as illustrated in Chart B in FIG. 3. In other circumstances, two or more AVMs may be found to have such abnormal AVM Values, especially when a higher number of AVMs is used, such as 6, 8, or 10.

Reference is again made to FIG. 7. In greater detail, the Outlier Analysis may be conducted as follows. As discussed supra, if the AVM count is three 4020, generate the AVMerge Index, conclude the Outlier Analysis without further steps 4030 and use the first calculated AVM Merge Value and calculate the AVMerge Index 4080 and 4090.

In this example of one embodiment of the invention, if the AVM count is not three, then it is four, and Outlier Analysis is performed as follows (in other words, in this embodiment, Outlier Analysis requires a minimum of four AVMs). Standard deviations are calculated for all four sources 4040. If all the deviations are less than the Cutoff (see infra) 4050, generate an AVMerge Index 4030, then conclude the Outlier Analysis without further steps, and the first calculated AVM Merge Value is used. If all the deviations are not less than the Cutoff, check the number of AVM values greater than the cutoff 4060 using the methods of the invention. If there is only one AVM value 4070, remove this AVM above the cutoff, also known as the “Outlier,” and recalculate the AVMerge; followed by recalculating the AVMerge Index 4070, and return 4030. In this embodiment, the Outlier Analysis is concluded 4030.

If, on the other hand, more than one AVM source is greater than the cutoff 4060, conclude the Outlier Analysis 4030 and return the AVMerge Value 4030.

Following conclusion of the Outlier Analysis described in one embodiment as 4010, 4020, 4040, 4050, 4060, 4070 in FIG. 7, the AVMerge Index is calculated by taking the standard deviation 4080 divided by the AVMerge price, subtracting that value from one and multiplying by 100 4090.

(v) The Cutoff Value for Outlier Analysis

In preferred embodiments, the cutoff is a standard deviation of more than about 1.5. Other values of the cutoff, such as 1, about 1, 1.2, about 1.2, 1.4, about 1.4, 1.6, about 1.6, 1.8, about 1.8, 2, about 2, 2, about 2.2, 2.5, and about 2.5, are also encompassed by the instant invention.

Other statistical means for calculating deviations from a mean known to those of skill in the art may also be used, and equivalent values for cutoffs may be used instead of the above values for standard deviation analysis. Such means include standard curve-fitting analyses, e.g., least-squares analysis.

In a preferred embodiment of the invention, the cutoff value is calibrated up to four times per year using a list of 2000 (or more) property addresses within 30 days of loan closing. All addresses contain the Agreed Sale price (or equivalent value, for example as defined herein, the value of a refinance) and (if possible) any associated value opinion or appraisal. All AVMs in the list are run against the same list of property addresses to measure standard deviations of the AVM values returned for each address. The invention thus also allows for instant assessment of modifications to the cutoff value.

(vi) Refinance Proximity Percentage and Approval Rating

With reference again to FIG. 6, the AVMerge Value, together with the loan-plus-equity, may be used to set the maximum value of a loan with a TAP available for a given property and borrower. The relation of loan-plus-equity value of the property to the AVMerge Value may be expressed as the refinance Proximity Percentage. For example, if the AVMerge Value is within 10% of the equity-plus-requested loan amount (referred to for the purposes of this discussion as SP in FIG. 6) 3030, the refinance Proximity Percentage has been set at 10% and the AVMerge Index is greater than or equal to a user-set value (hereinafter known as the Approval Rating) 3040, then the policy is preliminarily approved. Thus the refinance Proximity Percentage may be increased or decreased by the loan provider (lender) and/or insurer to set the basis for the maximum loan available.

In preferred embodiments of the invention the refinance Proximity Percentage is 10% of the loan-plus-equity; thus, the AVMerge Value is 90% or greater of the equity-plus-the maximum loan amount as illustrated at 3030 in FIG. 6. In other embodiments, the refinance Proximity Percentage is, for example, within 30%, 20%, 18%, 17%, 16%, 15%, 14%, 13%, 12%, 11%, 10%, 9%, 8%, 7%, 6%, 4%, 3%, 2%, 1%, −1%, −2%, −3%, −4% or −5% of the maximum loan-plus-equity amount; the exact value of the refinance Proximity Percentage to be used is set by the lender and/or the insurer. In preferred embodiments of the invention, policies will only be approved when the Approval Rating value of the AVMerge Index is about 85 or higher, as illustrated at 3040 in FIG. 6. In other embodiments, the Approval Rating value of the AVMerge Index is set at one of the following values (where the stated value is the lower limit) 80, about 80, 82, about 82, 84, about 84, about 85, 86, about 86, 87, 88, about 88, 89, 90, about 90, 92, or about 92.

Preferably all potentially successful transactions are subjected to Flip Detection in the use of the method of the instant invention illustrated at 3050 in FIG. 6 and in greater detail at 5010 in FIG. 8. If the transaction passes the Flip Detection, as illustrated at 3150 in FIG. 6, the transaction is passed 3160, and the subroutine ends; if the transaction does not pass the Flip Detection 3150, the transaction fails 3020.

If the AVMerge Value is not within the refinance Proximity Percentage of the requested loan-plus-equity amount, and/or the AVMerge Value is less than the Approval Rating value 3040, the instant invention fails to return a positive result with regard to approving and/or issuing a policy to validate the requested loan 3020 (i.e., approving and/or issuing a TAP) and the transaction ends.

If, however, the policy is not approvable at this point because the AVMerge Value is not within the refinance Proximity Percentage of the loan-plus-equity amount, a full Post-Pull analysis may be conducted at 1160, for example, in one embodiment of the invention illustrated in FIG. 6.

(vii) Focusing

An optional, yet important, part of the Post Pull analysis is referred to herein as Focusing with reference again to one embodiment of the invention as illustrated in FIG. 6, a transaction is reviewed to see if focusing is already done 3060. If yes, the transaction is terminated 3020.

If the AVMerge Value is not within the refinance Proximity Percentage of the loan-plus-equity amount 3030, but the AVMerge Value is within the (refinance Proximity Percentage−X) of the loan-plus-equity amount, a Post-Pull focusing analysis may be 3060 performed and may allow successfully approving and/or issuing a TAP for the loan. Preferred values of X are 1%, about 1%, 2%, and about 2% 3070.

In an example of Focusing Analysis, as illustrated in FIG. 6, the sorted list of AVMs is consulted, the next AVM Value is selected 3080, then inserted into the database 3090. If the AVM is a no-hit result 3100 (i.e., the AVM vendor fails to return an AVM for the property in question), the instant invention returns to the sorted AVM list and selects the next value 3080 for insertion into the database 3090, and the check for a no-hit 3100 repeats. If a valid AVM is available, the new AVM is compared to the previous AVMerge Value 3110. If the new AVM value is less than the former AVMerge Value 3110, the selection of a new AVM is repeated 3080 until no more sorted AVMs are available, at which point the transaction fails 3020. If the new AVM is greater than the last AVMerge Value 3110, the current pool is checked to see if it has four AVM values 3120 as illustrated in FIG. 6. If yes, the lowest AVM value is dropped 3130, if not, the new AVM is added to the pool 3130, and the AVMerge and AVMerge Index is calculated afresh 3140 and, in some embodiments, as illustrated in greater detail in FIG. 7, and the process continues.

(viii) Flip Analysis

However, in some embodiments of the invention, the transaction is subjected to a Flip Detection Analysis as described elsewhere

(m) Conclusion:

If, based on the criteria and the methods of the instant invention as described above, the Transaction Assurance Policy (“TAP”) is approvable, thus an insurance policy on the loan is approved, may be approved, is issued and/or may be issued, and the bank does not need an appraisal. (For example, see, 3160 in FIG. 6). In other embodiments, the instant invention may be used for direct approval of the loans, and the loan may be approved, funded, or authorized for funding at this point.

(n) TAP Activation Process

Similarly to its use in the property buying aspects, the prospective borrower for a refinance may be offered a choice and may order/purchase a TAP certificate in two steps. First, the customer may order a pre-qualification decision, called a First Look. In a First Look analysis, the full TAP analysis is conducted using all the necessary data and a decision is generated on the computer/database/program but a TAP is not issued. (For example, when a transaction is passed at 3160 (FIG. 6), a TAP may be issued instantly by the appropriate vendor or the user of the instant invention.) The overall process is conducted largely as described elsewhere herein.

Although the above description discusses the process of obtaining, approving and/or issuing a TAP using an exemplary set of values, one of skill in the art realizes that different numbers could be used in the methods of the instant invention. Thus, as a non-limiting example as discussed supra, the desired number of AVMs in a pool is four, with three being the minimum, other quantities of AVMs could also be used within the instant invention. Thus, the desired number of AVMs may be two, three, four, five, six, seven, eight, nine or ten. The minimum number of AVMs may be two, three, four, five, six, seven, eight, nine or ten. In addition, the user of the instant invention may input their own desired set of values for many of the terms encompassed by the instant invention such as the Proximity Percentage, desired credit rating, the parameters of FLIP detection, and many other settings in the instant invention. Further, although the above description primarily uses an example of obtaining or insuring a loan for a home purchase, one of skill in the art realizes that the instant invention could be readily used for obtaining or insuring a loan for refinancing.

Further, although the instant invention is described as a means for issuing a TAP, the instant invention also envisions the lender using the invention directly, in a process known as the AVM-Driven Loan Approval Process (A-DLAP). Several, almost all, or all the steps described herein as being involved in obtaining a TAP may also be used in obtaining an A-DLAP.

### EXAMPLES

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

The values in Examples 1, 2, 3, and 4 below are taken from actual real estate or refinancing transactions and TAPs could have been issued as noted.

### Example 1

The following is an example of the Outlier Analysis. In a transaction 1-A, a home sale, the Agreed Sales Price is $227,100, and the appraised (human appraiser) value is $229,000. Four AVM vendors furnish the following values for the property: (1) $210,000; (2) $201,000; (3) $397,000; and (4) $275,194. This yields an AVMerge Value of $270,798.50. The standard deviations of the four AVMs are: (1) 0.78; (2) 0.89; (3) 1.61; and (4) 0.06. The mean variance is 24.11, and the AVMerge Index is 71.09. (The “mean variance” is defined for these purposes as the mean of the four percentage differences between the AVMs in use and the AVMerge Value calculated from them. (In other words, the variance for AVM#1 of $210,000 is 22.5% less than $270.798.50, etc., and the mean of the four percentage variances is 24.11)) This AVMerge Index was insufficient to issue or approve a TAP at this point.

With use of the optional but preferred Outlier Analysis component of the instant invention, one of the AVMs (AVM #3) has a standard deviation greater than 1.5. Therefore the Outlier Analysis rejects this value and the computer/program/database calculates the AVMerge Value using the remaining three AVMs. This produces a “CEffect” AVMerge Value of $228,731.33, a CEffect Mean Variance of 13.54, and a CEffect Index of 85.55. Thus, performing the Outlier Analysis produces a higher AVMerge Index and only after the Outlier Analysis could a TAP be approved and/or issued.

| | AVM | | Deviation |
|---|---|---|---|
| Sales Price | #1: | $210,000 | 0.78 |
| $227,100 | #2: | $201,000 | 0.89 |
| Appraised Value | #3: | $397,000 | 1.61 |
| $229,000 | #4: | $275,194 | 0.06 |
| | | | Mean Variance = 24.11 |
| | | AVMerge Value | AVMerge Index |
| | | $270,798.50 | 71.09 |
| | #1: | $210,000 | 0.78 |
| | #2: | $201,000 | 0.89 |
| | #4: | $275,194 | 0.06 |
| | | | CEffect M. Var. = 13.54 |
| | | CEffect AVMerge | CEffect Index |
| | | Value | |
| | | $228,731.33 | 85.55 |

In transaction 1-B, a home sale, the Agreed Sales Price is $112,900, and the appraised value is $114,000. Four AVM vendors furnish the following values for the property: (1) $113,000; (2) $195,000; (3) $116,000; and (4) $113,799. This yields an AVMerge Value of $134,449.75. The standard deviations of the four AVMs are: (1) 0.61; (2) 1.73; (3) 0.53; and (4) 0.59. The mean variance is 22.51, and the AVMerge Index is 73.99. This AVMerge Index would be insufficient to fund a loan at the Agreed Sales Price at this point.

Again using the Outlier Analysis, one of the AVMs (AVM #2) has a standard deviation greater than 1.5. Therefore the Outlier Analysis rejects this value and the computer/program/database calculates the AVMerge Value using the remaining three AVMs. This produces a “CEffect” AVMerge Value of $114,266.33, a CEffect Mean Variance of 1.01, and a much higher CEffect Index of 98.89. Thus, performing the Outlier Analysis produces a higher AVMerge Index and only after the Outlier Analysis could a TAP be approved and/or issued.

| | AVM | | Deviation |
|---|---|---|---|
| Sales Price | #1: | $113,000 | 0.61 |
| $112,900 | #2: | $195,000 | 1.73 |
| Appraised Value | #3: | $116,000 | 0.53 |
| $114,000 | #4: | $113,799 | 0.59 |
| | | | Mean Variance = 22.51 |
| | | AVMerge Value | AVMerge Index |
| | | $134,449.75 | 73.99 |
| | #1: | $113,000 | 0.61 |
| | #3: | $116,000 | 0.53 |
| | #4: | $113,799 | 0.59 |
| | | | CEffect M. Var. = 1.01 |
| | | CEffect AVMerge | CEffect Index |
| | | Value | |
| | | $114,266.33 | 98.89 |

### Example 2

The following is an example of how two widely different transactions can produce the same mean variance, which is simply the mean percentage difference between the each AVM and the AVMerge Value.

In transaction 2-A, a refinance, the appraised value is $200,000. Four AVM vendors furnish the following values for the property: (1) $181,000; (2) $192,000; (3) $188,000; and (4) $189,983. This yields an AVMerge Value of $187,745.75. The standard deviations of the four AVMs are: (1) 1.63; (2) 1.03; (3) 0.06; and (4) 0.54. The mean variance is 1.79, and the AVMerge Index is 97.79. Another way to review the data presented is the Mean Variance entry; in this case, 1.79. Based on this analysis, this set of four AVMs are acceptable and a TAP could be approved and/or issued. Nevertheless, the Outlier Analysis may still be performed.

Under the Outlier Analysis, one of the AVMs has a standard deviation greater than 1.5. Therefore the Outlier Analysis rejects this value and the computer/program/database calculates the AVMerge Value using the remaining three AVMs. This produces a “CEffect” AVMerge Value of $189,994.33, a CEffect Mean Variance of 0.71, and a CEffect Index of 99.14. Thus, although the TAP could have been approved and/or issued prior to the Outlier Analysis, performing the Outlier Analysis produces a higher AVMerge Index and is preferable, and also results in the TAP being able to be approved and/or issued.

| | AVM | | Deviation |
|---|---|---|---|
| Sales Price | #1: | $181,000 | 1.63 |
| n/a: REFI | #2: | $192,000 | 1.03 |
| Appraised Value | #3: | $188,000 | 0.06 |
| $200,000 | #4: | $189,983.00 | 0.54 |
| | | | Mean Variance = 1.79 |
| | | AVMerge Value | AVMerge Index |
| | | $187,745.75 | 97.79 |
| | | | CEffect M. Var. = 0.71 |
| | | CEffect AVMerge | CEffect Index |
| | | Value | |
| | | $189.994.33 | 99.14 |

In transaction 2-B, a home sale, the Agreed Sales Price was $127,500, and the appraised value was $132,000. Four AVM vendors furnished the following values for the property: (1) $134,000; (2) $129,000; (3) $134,000; and (4) $138,251. This yields an AVMerge Value of $133,812.75. The standard deviations of the four AVMs are: (1) 0.06; (2) 1.03; (3) 0.06; and (4) 0.54. The mean variance is 1.79 (same as above), and the AVMerge Index is 97.79. Although the Outlier Analysis may formally be conducted, there are no standard deviations greater than 1.5 and thus there is no outlying value to reject. Therefore, this set of four AVMs is acceptable and a TAP is could be approved and/or issued.

| | AVM | | Deviation |
|---|---|---|---|
| Sales Price | #1: | $134,000 | 0.06 |
| 127,500 | #2: | $129,000 | 1.47 |
| Appraised Value | #3: | $134,000 | 0.06 |
| $132,000 | #4: | $138,251 | 1.35 |
| | | | Mean Variance = 1.79 |
| | | AVMerge Value | AVMerge Index |
| | | $133,812.75 | 97.55 |
| | | | CEffect M. Var. = n/a |
| | | CEffect AVMerge | CEffect Index |
| | | Value | |
| | | n/a | n/a |

### Example 3

In the example below, analysis of two different refmances produces the same index.

| | AVM | | Deviation |
|---|---|---|---|
| Sales Price | #1: | $199,000 | 1.16 |
| n/a: REFI | #2: | $225,000 | 1.59 |
| Appraised Value | #3: | $209,000 | 0.10 |
| $205,000 | #4: | $206,748 | 0.34 |
| | | | Mean Variance = 3.58 |
| | | AVMerge Value | AVMerge Index |
| | | $209,937 | 95.50 |
| | | | CEffect M. Var. = 1.92 |
| | | CEffect AVMerge | CEffect Index |
| | | Value | |
| | | $204,916 | 97.91 |

| | AVM | | Deviation |
|---|---|---|---|
| Sales Price | #1: | $188,000 | 1.28 |
| n/a: REFI | #2: | $205,000 | 0.62 |
| Appraised Value | #3: | $194,000 | 0.61 |
| $200,000 | #4: | $210,858 | 1.27 |
| | | | Mean Variance = 4.24 |
| | | AVMerge Value | AVMerge Index |
| | | $199,464.50 | 95.50 |
| | | | CEffect M. Var. = n/a |
| | | CEffect AVMerge | CEffect Index |
| | | Value | |
| | | n/a | n/a |

### Example 4

In the example below, similar to Example 3 above, analysis of two different refinances produces the same index. In the first REFI where the AVMerge Value is $265,507.25, the CEffect is not triggered as none of the deviations are above 1.5.

| | AVM | | Deviation |
|---|---|---|---|
| Sales Price | #1: | $258,000 | 0.28 |
| n/a: REFI | #2: | $230,000 | 1.34 |
| Appraised Value | #3: | $270,000 | 0.17 |
| $266,000 | #4: | $304,029 | 1.45 |
| | | | Mean Variance = 8.10 |
| | | AVMerge Value | AVMerge Index |
| | | $265,507.25 | 90.00 |
| | | | CEffect M. Var. = n/a |
| | | CEffect AVMerge | CEffect Index |
| | | Value | |
| | | n/a | n/a |

| | AVM | | Deviation |
|---|---|---|---|
| Sales Price | #1: | $152,000 | 0.84 |
| n/a: REFI | #2: | $142,000 | 0.13 |
| Appraised Value | #3: | $150,000 | 0.70 |
| $145,000 | #4: | $116,806 | 1.67 |
| | | | Mean Variance = 8.34 |
| | | AVMerge Value | AVMerge Index |
| | | $140,201.50 | 90.00 |
| | | | CEffect M. Var. = 2.70 |
| | | CEffect AVMerge | |
| | | Value | CEffect Index |
| | | $148.000 | 97.08 |

The invention illustratively described herein can suitably be practiced in the absence of any element or elements, limitation or limitations that is not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalent of the invention shown or portion thereof, but it is recognized that various modifications are possible within the scope of the invention claimed. Thus, it should be understood that although the present invention has been specifically disclosed by preferred embodiments and optional features, modifications and variations of the inventions embodied herein disclosed can be readily made by those skilled in the art, and that such modifications and variations are considered to be within the scope of the inventions disclosed herein. The inventions have been described broadly and generically herein. Each of the narrower species and subgeneric groupings falling within the generic disclosure also form the part of these inventions. This includes within the generic description of each of the inventions a proviso or negative limitation that will allow removing any subject matter from the genus, regardless or whether or not the material to be removed was specifically recited. In addition, where features or aspects of an invention are described in terms of the Markush group, those schooled in the art will recognize that the invention is also thereby described in terms of any individual member or subgroup of members of the Markush group. Further, when a reference to an aspect of the invention lists a range of individual members, as for a non-limiting example, ‘the letters A through F, inclusive,’ it is intended to be equivalent to listing every member of the list individually, that is ‘A, B, C, D, E and/or F,’ and additionally it should be understood that every individual member may be excluded or included in the claim individually.

The steps depicted and/or used in methods herein may be performed in a different order than as depicted and/or stated. The steps are merely exemplary of the order these steps may occur. The steps may occur in any order that is desired such that it still performs the goals of the claimed invention.

From the description of the invention herein, it is manifest that various equivalents can be used to implement the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are considered in all respects as illustrative and not restrictive. It should also be understood that the invention is not limited to the particular embodiments described herein, but is capable of many equivalents, rearrangements, modifications, and substitutions without departing from the scope of the invention. Thus, additional embodiments are within the scope of the invention and within the following claims.

What is claimed is:

1. A computerized mortgage loan evaluation method comprising the steps of:
(a) inputting into a computer/database/program:
(i) an Agreed Sale Price between a borrower and a seller for a piece of real property,
(ii) the identity of said borrower,
(iii) the unique identity of said property,
(iv) an amount of cash provided by said borrower,
(v) a requested loan amount,
(vi) a Proximity Percentage and an Approval Rating requested by a loan originator or insurer, and
(vii) retrieving a list of currently available AVMs;
(c) selecting a subset of AVMs from said available set of AVMs;
wherein a TAP is approved and/or issued if
(i) said subset of AVMs comprises three individual AVMs or four individual AVMs,
(ii) said subset of AVMs have an AVMerge Index following Outlier Analysis greater than said Approval Rating, and
(iii) said subset of AVMs has a Focused AVMerge Value within said Proximity Percentage of said Agreed Sale Price.

2. A computerized mortgage loan evaluation method comprising the steps of:
(a) inputting into a computer/database/program:
(i) a requested loan amount by a borrower for refinancing a piece of real property,
(ii) the identity of said borrower,
(iii) the unique identity of said property,
(iv) an amount of cash and/or equity in said real property provided by said borrower,
(v) a Proximity Percentage and an Approval Rating requested by a loan originator or insurer, and
(vi) retrieving a list of currently available AVMS; and
(b) selecting a subset of AVMs from said available set of AVMs
wherein a TAP is approved and/or issued if
(i) said subset of AVMs comprises three individual AVMs or four individual AVMs,
(ii) said subset of AVMs has an AVMerge Index following Outlier Analysis greater than said Approval Rating, and
(iii) said subset of AVMs has a Focused AVMerge Value within said Proximity Percentage of an Agreed Sale Price.

3. A computerized mortgage loan evaluation method for refinancing a piece of real property comprising the steps of:
(a) inputting into a computer/database/program:
(i) the identity of a borrower,
(i) a unique identity of said property,
(iv) an amount of cash and/or equity in said real property provided by said borrower,
(v) a Proximity Percentage and an Approval Rating requested by a loan originator or insurer, and
(vi) retrieving a list of currently available AVMs; and
(b) selecting a subset of AVMs from said available set of AVMs;
(c) using said Proximity Percentage and said amount of cash and/or equity provided by said borrower to calculate a maximum available loan,
wherein a TAP is approved and/or issued if
(i) said subset of AVMs has an AVMerge Index greater than said Approval Rating,
(ii) the loan requested is less than or equal to the maximum available loan, and
(iii) said subset of AVMs has a Focused AVMerge Value within said Proximity Percentage of an Agreed Sale Price or acceptable home value.

4. The method of claim 1 wherein said AVMerge Value has been subjected to focusing analysis.

5. The method of claim 2 wherein said AVMerge Value has been subjected to focusing analysis.

6. The method of claim 3 wherein said AVMerge Value has been subjected to focusing analysis.

7. The method of claim 1 wherein said AVMerge Index has been subjected to Outlier Analysis.

8. The method of claim 2 wherein said AVMerge Index has been subjected to Outlier Analysis.

9. The method of claim 3 wherein said AVMerge Index has been subjected to Outlier Analysis.

10. The method of claim 1 wherein three or four AVMs are used.

11. The method of claim 2 wherein three or four AVMs are used.

12. The method of claim 3 wherein three or four AVMs are used.

13. The method of claim 1 wherein said Proximity Percentage is 90% or more of said Agreed Sale Price.

14. The method of claim 2 wherein said Proximity Percentage is 90% or more of said Agreed Sale Price.

15. The method of any of claims 3 wherein said Proximity Percentage is 90% or more of a requested valuation of said real property for obtaining a refinancing loan.

16. The method of claim 1 wherein said Approval Rating is greater than 85.

17. The method of claim 2 wherein said Approval Rating is greater than 85.

16. The method of claim 3 wherein said Approval Rating is greater than 85.

17. The method of claim 1 wherein said borrower and said seller have negotiated said Agreed Sale Price.

18. The method of claim 2 wherein said borrower and said seller have negotiated said Agreed Sale Price.

19. The method of claim 1 wherein said Proximity Percentage is less than 90% of said Agreed Sale Price, but more than about 90−X % of said Agreed Sale Price wherein X is about 1, 1, about 2 or 2; and wherein said AVMerge Value is analyzed by a means for conducting a focusing analysis.

20. The method of claim 2 wherein said Proximity Percentage is less than 90% of said Agreed Sale Price, but more than about 90−X % of said Agreed Sale Price wherein X is about 1, 1, about 2 or 2; and wherein said AVMerge Value is analyzed by a means for conducting a focusing analysis.

21. The method of claim 1 wherein a TAP is issued following said approval of said TAP.

22. The method of claim 2 wherein a TAP is issued following said approval of said TAP.

23. The method of claim 3 wherein a TAP is issued following said approval of said TAP.

24. The method of claim 1 wherein a loan is insured based on an approved and/or issued TAP.

25. The method of claim 2 wherein a loan is insured based on an approved and/or issued TAP.

26. The method of claim 3 wherein a loan is insured based on an approved and/or issued TAP.

27. The method of claim 1 wherein said borrower purchases a First Look option whereby said borrower is told whether or not said TAP is approved but said borrower is not issued said TAP until said borrower requests said TAP to be issued.

28. The method of claim 2 wherein said borrower purchases a First Look option whereby said borrower is told whether or not said TAP is approved but said borrower is not issued said TAP until said borrower requests said TAP to be issued.

29. The method of claim 3 wherein said borrower purchases a First Look option whereby said borrower is told whether or not said TAP is approved but said borrower is not issued said TAP until said borrower requests said TAP to be issued.

30. An apparatus for accomplishing claim 1.

31. An apparatus for accomplishing claim 2.

32. An apparatus for accomplishing claim 3.
